(19) United States
(12) Patent Application Publication
(10) Pub. No.: US 2012/0175200 A1
(43) Pub. Date: Jul. 12, 2012

(54) Customized Vehicle Deceleration

(75) Inventors: Clement Newman Sagan, Dearborn, MI (US); John Phillip McCormick, Milford, MI (US); Elizabeth Ann Scheuing, Canton, MI (US)

(73) Assignee: FORD GLOBAL TECHNOLOGIES, LLC, Dearborn, MI (US)

(21) Appl. No.: 12/987,612

(22) Filed: Jan. 10, 2011

(51) Int. Cl. B60T 8/17; B60T 8/171; B60T 8/32; G06F 19/00; B60T 13/10

(52) U.S. Cl. 188/159; 701/70; 188/355

(57) ABSTRACT

A system is provided for customized vehicle deceleration. The system includes a braking system and a brake pedal position sensor that transmits a brake pedal position signal. A user interface is configured for transmitting a profile selection signal in response to a user input. A controller is configured for receiving the brake pedal position signal, the profile selection signal and an available torque signal, the available torque signal being indicative of a braking system torque capability. The controller analyzes the profile selection signal, to select a brake profile from pre-existing data. The controller compares the brake pedal position signal to the brake profile to determine a deceleration value. The controller compares the deceleration value to the available torque signal to determine a torque command. The controller transmits a torque command signal to the braking system for initiating braking.

### BACKGROUND

1. Technical Field

One or more embodiments relate to a brake system and vehicle deceleration.

2. Background Art

Vehicle braking systems are designed to stop a vehicle within a specified distance. Vehicle braking systems are also calibrated for decelerating the vehicle at a rate that corresponds to a brake pedal travel position. By depressing the brake pedal farther (e.g., in a panic stop) a higher deceleration is applied to stop the vehicle in a shorter distance. Vehicles may be calibrated with different braking profiles. For example, a sports car may be calibrated to provide a more aggressive braking profile than a minivan.

### SUMMARY

In at least one embodiment, a system is provided for customized vehicle deceleration. The system includes a braking system and a brake pedal position sensor that transmits a brake pedal position signal. A user interface is configured for transmitting a profile selection signal in response to a user input. A controller is configured for receiving the brake pedal position signal, the profile selection signal and an available torque signal, the available torque signal being indicative of a braking system torque capability. The controller analyzes the profile selection signal to select a brake profile from pre-existing data. The controller compares the brake pedal position signal to the brake profile to determine a deceleration value. The controller compares the deceleration value to the available torque signal to determine a torque command. The controller transmits a torque command signal to the braking system for initiating braking.

In another embodiment, a vehicle braking system is provided with a controller configured to receive a brake pedal position signal and a profile selection signal. The controller selects a brake profile based on pre-existing data and the profile selection signal. The controller compares the brake pedal position signal to the brake profile to determine a deceleration value; and determines a torque command using the deceleration value.

In yet another embodiment, a method for controlling a customized vehicle deceleration system is provided. A brake pedal position signal and a profile selection signal are received. The profile selection signal is analyzed to select a brake profile from pre-existing data. The brake pedal position signal is compared to the brake profile to determine a deceleration value. The deceleration value is analyzed to determine a torque command. And a torque command signal is transmitted that is indicative of the torque command.

### BRIEF DESCRIPTION OF THE DRAWINGS

FIG. 1 is a schematic view of a system for customized vehicle deceleration according to an embodiment;

FIG. 2 is a schematic diagram further illustrating the system of FIG. 1;

FIG. 3 is a plot illustrating brake profiles for the system of FIG. 1;

FIG. 4 is a front perspective view of a user interface of the system of FIG. 1;

FIG. 5 is a flow chart illustrating a method for selecting a brake profile from FIG. 3;

FIG. 6 is a flow chart illustrating a method for activating a selected brake profile from FIG. 5;

FIG. 7 is a schematic view of a system for customized vehicle deceleration according to additional embodiments;

FIG. 8 is a schematic view of a braking system for the system of FIG. 7; and

FIG. 9 is a schematic view of another braking system for the system of FIG. 7.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for the claims, and/or as a representative basis for teaching one skilled in the art to variously employ the present invention.

In general, vehicle manufacturers calibrate vehicles with common braking profiles. However, different users have different braking profile preferences. A system is provided to allow the user to select a braking profile from a set of pre-determined braking profiles to accommodate their individual braking preferences.

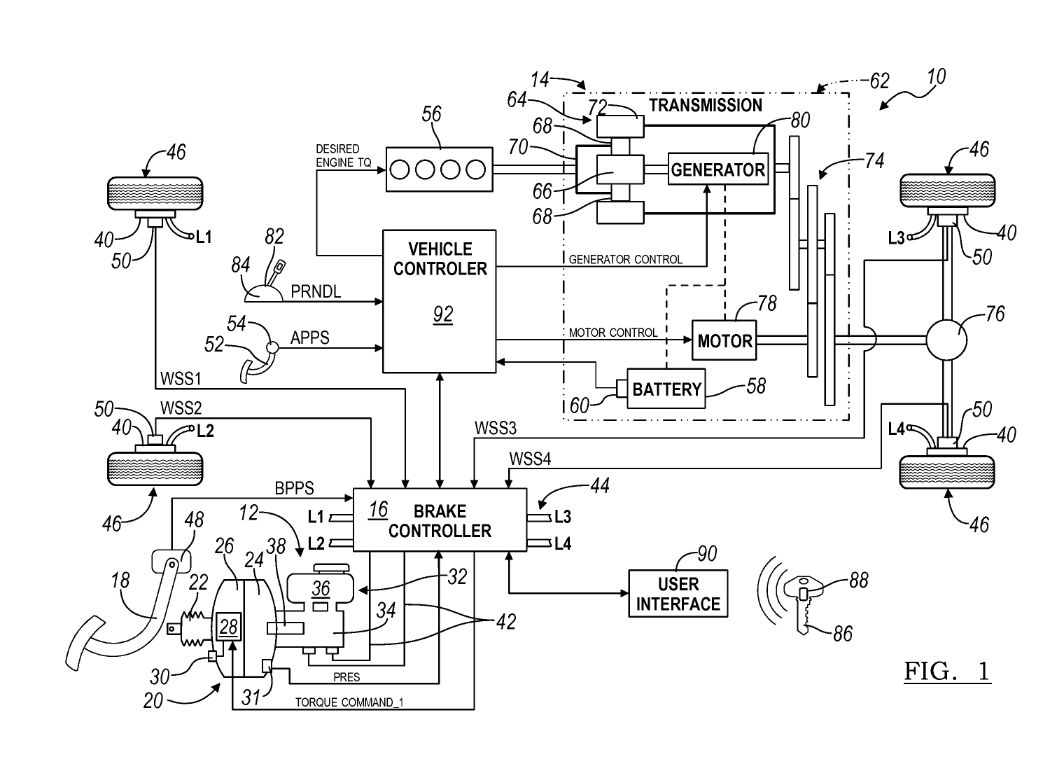

With reference to FIG. 1, a system for customized vehicle deceleration is illustrated in accordance with an embodiment and is generally referenced by numeral 10. The system 10 includes a first braking system 12 and a second braking system 14 that may cooperatively or individually decelerate a vehicle. The first braking system 12 is a friction braking system. The system 10 also includes a brake controller 16 for electronically controlling the contribution of the second braking system 14.

The first brake system 12 includes a brake pedal 18 for receiving an input force indicative of a desire to decelerate a vehicle. The brake pedal 18 is pivotally coupled to a vehicle support structure, such as a floorpan or firewall (not shown). The brake pedal 18 receives a mechanical input force that is exerted by the user. The brake pedal 18 multiplies the input force by a lever ratio defined by a brake pedal geometry to provide a brake pedal output.

The brake pedal 18 may be coupled to a booster 20 by an actuating rod 22. The actuating rod 22 is spaced apart from the brake pedal 18 and adapted to engage an intermediate portion of the brake pedal 18 for receiving the brake pedal output during certain operating conditions (e.g., during rapid deceleration or when the second braking system 14 is unavailable). The first braking system 12 may include a biasing member (e.g., a return spring) (not shown) to provide a reactionary force in opposition to the brake pedal input force.

The booster 20 multiplies the braking force provided by the brake pedal 18. The booster 20 includes a generally hollow body 24. A flexible diaphragm 26 extends through a central portion of the body 24 to form two adjacent chambers. The body 24 is sealed and both chambers are maintained at a common low pressure.

The booster 20 includes an actuator 28 and an air valve 30 which are coupled to each other for adjusting the air pressure within the body 24. The air valve 30 lets in atmospheric pressure air to one chamber of the booster 20. Since the pressure becomes higher in one chamber, the diaphragm 26 moves toward the lower pressure chamber with a force multiplied by a booster ratio to provide a booster output force. The booster ratio is defined by an area of the diaphragm 26 and the differential pressure.

The brake controller 16 electronically controls the first braking system 12 and the second braking system 14 during normal operating conditions. The brake controller 16 controls the first braking system 12, by sending a command signal (TORQUE COMMAND_1) to the actuator 28. The actuator 28 actuates the air valve 30 in response to TORQUE COMMAND 1.

The booster 20 includes a booster sensor 31 for measuring an internal pressure within the body 24. The booster sensor 31 provides an input signal (PRES) to the brake controller 16 that is indicative of the internal pressure.

A master cylinder 32 is attached to the booster 20 for receiving the booster output force. The master cylinder 32 includes a cylinder body 34 and a fluid reservoir 36 attached to each other. The cylinder body 34 forms an inner cavity that is sized for receiving a piston 38. The piston 38 extends into the body 24 of the booster 20 for receiving the booster output force. The cylinder body 34 and the fluid reservoir 36 contain a non-compressible brake fluid (not shown) which circulates between the cylinder body 34 and the reservoir 36. When subjected to the booster output force, the piston 38 translates into the inner cavity of the cylinder body 34. The piston 38 displaces the brake fluid within the cylinder body 34 and creates hydraulic brake pressure.

The master cylinder 32 is coupled to brake calipers 40 for transferring the brake pressure. A pair of hydraulic circuits 42 are each connected to the cylinder body 34 for receiving the brake pressure. Each circuit 42 splits into two brake lines 44 to form a total of four brake lines 44. The brake lines 44 are depicted as L1, L2, L3 and L4 in FIG. 1. Each line 44 typically includes a metal brake tube coupled to a brake hose at the caliper 40.

Each brake caliper 40 is mounted to a wheel assembly 46 for applying a braking torque. Each caliper 40 includes at least one brake piston (not shown) in fluid communication with a brake line 44. The brake piston is actuated by the brake pressure to apply a clamp load upon a rotating brake rotor (not shown). The clamp load results in a frictional brake torque applied to the wheel assembly 46 for decelerating the vehicle.

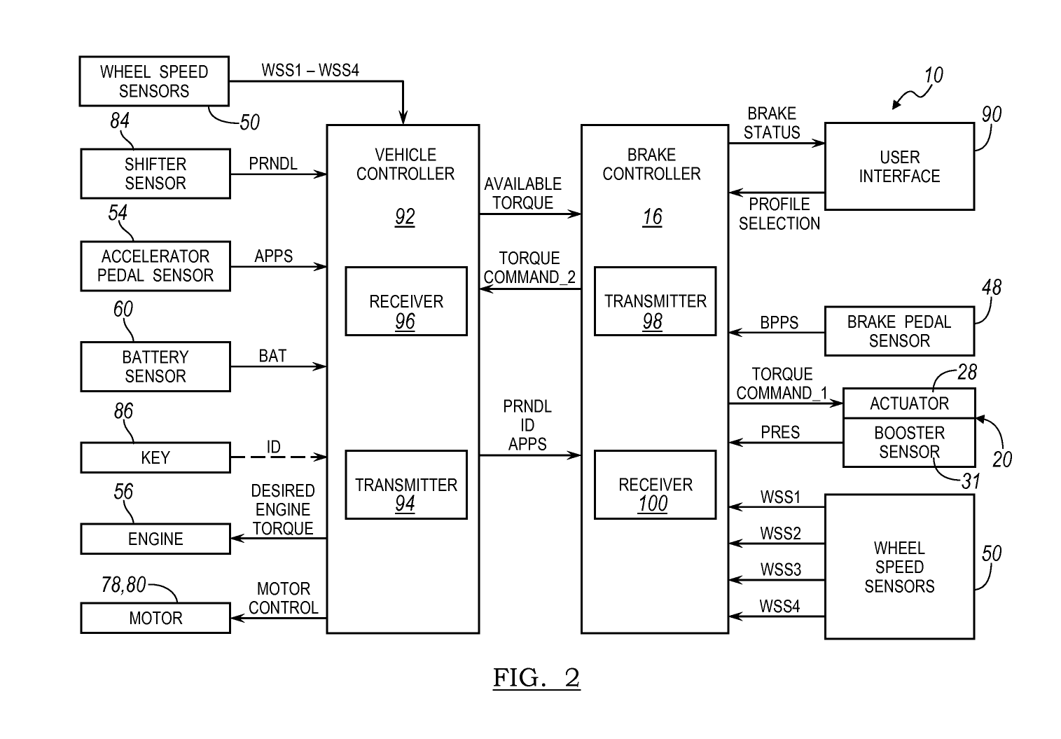

Referring to FIGS. 1 and 2, the system 10 includes a brake pedal position sensor 48 for measuring a position of the brake pedal 18. The brake pedal position sensor 48 transmits an input signal (BPPS) to the brake controller 16 that is indicative of an angular position of the brake pedal 18. The brake pedal position sensor 48 may be hardline connected to the brake controller 16. Alternatively, the brake controller 16 may receive the BPPS signal over a vehicle BUS communication network (e.g., CAN).

A wheel speed sensor 50 is provided for measuring wheel speed. The wheel speed sensor 50 may be mounted to the wheel assembly 46, and adapted to measure a rotating member. For example, the wheel speed sensor 50 may be an encoder that is triggered by projections on a rotating member. The wheel speed sensor 50 transmits an input signal (WSS1) to the brake controller 16 that is indicative of an angular velocity of the rotating member. The illustrated embodiment includes four wheel speed sensors 50 for providing four wheel speed sensor signals (WSS1, WSS2, WSS3 and WSS4), however other quantities of sensors may be provided. Each wheel speed sensor 50 may be hardline connected to the brake controller 16. Alternatively the brake controller 16 may receive the WSS1-WSS4 signals over a vehicle BUS communication network (e.g., CAN).

The system 10 includes an accelerator pedal 52 for receiving an input force indicative of a desire to accelerate the vehicle. The accelerator pedal 52 is pivotally attached to the vehicle support structure in proximity to the brake pedal 18. The accelerator pedal 52 receives a mechanical input force that is exerted by a user. The accelerator pedal 52 may include a biasing member (e.g., a return spring) to provide a reactionary force in opposition to the input force (not shown).

An accelerator pedal position sensor 54 is provided for measuring a position of the accelerator pedal 52. The accelerator pedal position sensor 54 may be attached to a fixed portion of the accelerator pedal 54, and actuated by a pivoting portion of the accelerator pedal 54. The accelerator pedal position sensor 48 transmits an input signal (APPS) that is indicative of an angular position of the accelerator pedal 54. The brake controller 16 may receive the APPS signal over a vehicle BUS communication network (e.g., CAN).

Alternatively, the accelerator pedal position sensor 54 may be hardline connected to the brake controller 16 for providing the APPS signal.

The system 10 includes an engine 56 for propelling the vehicle. The engine 56 is indirectly connected to the wheel assemblies 46 for propelling the vehicle. The engine 56 provides an engine output, comprising a torque and angular velocity, that correlates to the APPS signal.

The system 10 includes a battery assembly 58 for storing electrical power. The system may include multiple battery assemblies 58. For example, a hybrid electric, or electric vehicle may include high and low voltage battery assemblies 58.

A battery sensor 60 is provided for measuring an electrical power level of the battery assembly 58. The battery sensor 60 transmits an input signal (BAT) that is indicative of the electrical power of the battery assembly 58. The battery sensor 60 may be configured for measuring the voltage or current stored within the battery assembly 58.

The system 10 includes a transmission 62 for connecting the engine output to the wheel assemblies 46 for propelling the vehicle. The transmission 62 may mechanically connect the engine output to two wheel assemblies 46 or all four wheel assemblies 46.

In one embodiment, the transmission 62 includes a power-split configuration with a single stage planetary gear set 64. The planetary gear set 64 includes a centrally located sun gear 66. Planet gears 68 mesh with the sun gear 66. The planet gears 68 revolve around the sun gear 66. Each planet gear 68 is rotatably connected to a common carrier 70. Each planet 68 also meshes with an outer ring gear 72 having internal teeth. The ring gear 72 provides the output of the planetary gear set 64, and is connected through a series of additional intermediate gears, which are generally indicated by numeral 74 to a differential 76. The differential 76 attaches to two wheel assemblies 46 for propelling the vehicle.

The second braking system 14 is also provided for decelerating the vehicle. The second braking system 14 may include a first motor 78 and a second motor 80 that are each coupled to the transmission 62. The first motor 78 is connected to the intermediate gears 74. The second motor 80 is connected to the sun gear 66. Other embodiments of the system 10 include one motor, or more than two motors.

Each motor 78, 80 is electrically connected to the battery assembly 58 and configured for acting as either a motor or a generator. When acting as a generator, the motors 78, 80 apply a torque to the transmission and or the engine that acts as regenerative braking for decelerating the vehicle.

The system 10 includes a shifter 82 coupled to the transmission 62 for selecting a transmission gear. A shifter position sensor 84 is provided for measuring a gear selection. The shifter position sensor 84 transmits an input signal (PRNDL) that is indicative of a gear selection made by the shifter 82. The brake controller 16 may receive the PRNDL signal over a vehicle BUS communication network (e.g., CAN). Alternatively, the shifter position sensor 84 may be hardline connected to the brake controller 16 for providing the PRNDL signal.

The system 10 includes an ignition key 86 for unlocking the vehicle and starting an ignition system (not shown). The ignition key 86 may include a transmitter 88 for transmitting an identification signal (ID) that is indicative of an identity of a user of the specific ignition key 86. A user may possess multiple keys 86 for their vehicle, where each key transmits a distinct ID signal. Distinct ID signals may be used to configure different vehicle use. For example, a primary user may limit certain vehicle accessories that are accessible to a secondary user. A description of the functionality of such a key 86 is described in U.S. application Ser. Nos. 12/026,852 and 12/139,005 both to Miller et al.

A user interface 90 is provided for allowing the user to manually select a desired brake profile. The user interface 90 is located in an interior of a vehicle and accessible by the user. The user interface 90 may include a switch, sensor or touch screen for receiving a manual input from the user. The user interface 90 transmits an input signal (PROFILE SELECTION) that is indicative of a brake profile selection made by the user. The brake controller 16 may receive the PROFILE SELECTION signal over a vehicle BUS communication network (e.g., CAN). Additionally, the user interface 90 may be hardline or wirelessly connected to the brake controller 16.

Referring to FIG. 2, the system 10 includes a vehicle controller 92 in communication with the brake controller 16. The vehicle controller 92 includes a vehicle transmitter 94 and a vehicle receiver 96. The brake controller 16 includes a transmitter 98 and a receiver 100 for communicating with each other. FIG. 2 illustrates only one transmitter 94, 98 and one receiver 96, 100 for each controller 92, 16. However, the system 10 contemplates a plurality of receivers, transmitters and transceivers being implemented. For example a specific receiver and transmitter may be used for each type of communication (e.g., hardline, CAN, RF wireless, etc.). The brake controller 16 and the vehicle controller 92 may communicate with each other over the vehicle BUS communication network, or multiple vehicle BUS communication networks (e.g., high speed CAN and low speed CAN). Alternatively, the vehicle controller 92 may be hardline or wirelessly connected to the brake controller 16.

The brake controller 16 and the vehicle controller 92 each generally include any number of microprocessors, ASICs, ICs, memory (e.g., FLASH, ROM, RAM, EPROM and/or EEPROM) and software code to co-act with one another to perform a series of operations.

The vehicle controller 92 determines a regenerative braking torque capability of the second braking system 14. The vehicle controller 92 receives a plurality of input signals including: the wheel speed signal, the accelerator position signal, the battery power signal and the transmission gear selection signal over the vehicle BUS communication network or through hardline connections with their respective sensors. The vehicle controller 92 analyzes the input signals to determine a regenerative braking torque capability of the second braking system 14.

For example, if the wheel speed signals (WSS1-4) indicate that vehicle is traveling at an optimal speed for generating electrical power, and the battery signal (BAT) indicates that the battery assembly 58 is capable of receiving additional charge, then the vehicle controller 92 may determine that there is a high regenerative braking torque capability of the second braking system 14. However, if the battery power signal (BAT) indicates that the battery assembly 58 is fully charged, then the vehicle controller 92 may determine that there is a low braking torque capability, because excess current generated by regenerative braking could overcharge the battery assembly 58.

The vehicle controller 92 transmits an input signal (AVAILABLE TORQUE) to the braking controller 16, that is indicative of a braking torque capability of the second braking system 14. The brake controller 16 may receive the AVAILABLE TORQUE signal over a vehicle BUS communication network (e.g., CAN). Alternatively, the vehicle controller 92 may provide the signal wirelessly or by a hardline connection.

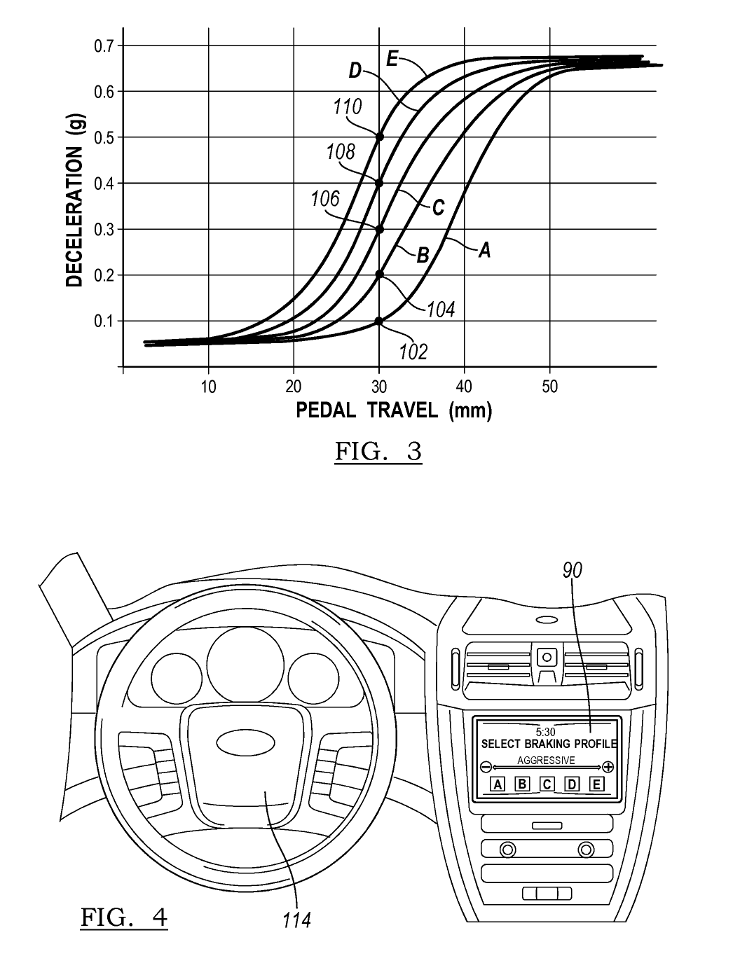

Referring to FIGS. 2-3, the system 10 is configured for decelerating the vehicle at a rate that corresponds to a brake pedal travel position. By depressing the brake pedal 18 farther (e.g., in a panic stop) a higher and more aggressive deceleration is applied to stop the vehicle in a shorter distance.

The brake controller 16 is configured with pre-existing data which includes vehicle deceleration calibration data. The pre-existing data includes a plurality of discrete brake profile curves, which are depicted as curves A,B,C,D and E in FIG. 3. Each brake profile curve A-E is defined by a series of data points having a brake pedal travel component and a vehicle deceleration component. The data points included in FIG. 3 are provided for illustrative purposes.

Curves A and E represent the outer boundaries of acceptable brake profile curves for a given vehicle application. Brake profile curve E represents an aggressive or “sporty” brake profile curve and generally has a high deceleration value for a corresponding brake pedal travel. Brake profile curve A represents a non-aggressive brake profile curve and generally includes low deceleration values for corresponding brake pedal travel values. Intermediate curves B-D represent intermediate braking profiles of increasing aggressiveness, that are generally equally spaced between curves A and E. For example, for a common pedal travel of 30 mm; curve A includes a deceleration component corresponding to 0.1 g and is referenced by numeral 102; curve B includes a deceleration component corresponding to 0.2 g and is referenced by numeral 104; curve C includes a deceleration component corresponding to 0.3 g and is referenced by numeral 106; curve D includes a deceleration component corresponding to 0.4 g and is referenced by numeral 108; and curve E includes a deceleration component corresponding to 0.5 g and is referenced by numeral 110.

The system 10 allows a user to select a brake profile curve A-E based on their own braking preferences. However, the user is not given unlimited options for selecting a brake profile. The user is limited to a discrete number of brake profile curves (e.g., curves A-E) within an acceptable brake profile range.

The brake controller 16 is also configured with pre-existing data corresponding to a torque capability of the first braking system 12. This pre-existing data includes a friction braking torque value corresponding to a given hydraulic line pressure.

Referring to FIGS. 2-4, the brake controller 16 is configured for receiving the profile selection signal (PROFILE SELECTION) from the user interface 90. The brake controller 16 analyzes the PROFILE SELECTION signal and selects a corresponding brake profile from pre-existing data (curves A-E). The user interface 90 depicted in FIG. 4, includes a touch screen 112 with icons corresponding to different brake profiles (e.g., curves A-E). Other embodiments of the system 10 include a user interface comprising buttons or switches on the steering wheel 114 which are also configured for manual input. Alternate embodiments of the system 10, include a user interface 90 configured for selecting a brake profile in response to a voice command.

The brake controller 16 determines a torque command in response to a brake pedal position signal. The brake controller receives the brake pedal position signal (BPPS) from the brake pedal position sensor 48. Next the brake controller compares the brake pedal position signal to the current brake profile to determine a deceleration value. The deceleration value corresponds to a desired overall braking torque. The brake controller 16 receives the available torque signal (AVAILABLE TORQUE) from the vehicle controller 92. The brake controller 16 then compares the deceleration value to the available torque signal and the first braking system torque capability to determine a torque command.

The brake controller 16 transmits a torque command signal (TORQUE COMMAND_2) to the vehicle controller 92 in response to the torque command value. The vehicle controller 92 receives the TORQUE COMMAND_2 signal, and controls the first motor 78 and/or the second motor 80 to regeneratively brake the vehicle at a corresponding torque value.

For example, the brake controller receives the brake pedal position signal (BPPS) from the brake pedal position sensor 48 that indicates a brake pedal travel of 25 mm. Next the brake controller compares the brake pedal position signal to the current brake profile (curve D) to determine a deceleration value of 0.2 g. The brake controller 16 receives the available torque signal (AVAILABLE TORQUE) which indicates that the secondary braking system 14 has a high available torque which is sufficient for providing the torque required to achieve a deceleration of 0.2 g. The brake controller 16 then compares the deceleration value to the available torque signal and the first braking system torque capability to determine a torque command, where the entire torque command is provided by the second braking system 14. Then the brake controller 16 transmits a TORQUE COMMAND_2 signal to the vehicle controller 92 to initiate regenerative braking.

In another example, the brake controller receives the brake pedal position signal (BPPS) from the brake pedal position sensor 48 that indicates a brake pedal travel of 30 mm. Next the brake controller compares the brake pedal position signal to the current brake profile (curve D) to determine a deceleration value of 0.4 g. The brake controller 16 receives the available torque signal (AVAILABLE TORQUE) which indicates that the secondary braking system 14 has a low available torque which is less than the torque required to achieve a deceleration of 0.4 g. The brake controller 16 then compares the deceleration value to the available torque signal and the first braking system torque capability to determine a torque command, where the torque command is split between the first and second braking systems 12 and 14. Then the brake controller 16 transmits a TORQUE COMMAND_1 signal to the actuator 28 to initiate friction braking, and transmits a TORQUE COMMAND_2 signal to the vehicle controller 92 to initiate regenerative braking.

The user interface 90 may display a brake status message corresponding to a brake status signal. The brake controller 16 may transmit a brake status signal (BRAKE STATUS) that is indicative of a current brake profile. For example the brake controller 16 may send a BRAKE STATUS signal indicating that brake profile curve C is current, or active. The user interface 90 may receive the BRAKE STATUS signal and display a corresponding brake status message.

The system 10 allows the user to select different brake profiles from pre-existing data. However, the system 10 only allows the user to change from one brake profile to another during certain vehicle conditions. For example, the system 10 may prevent the user from changing the brake profile while the vehicle is moving. Both the brake controller 16 and the user interface 90 may include software for defining the steps for enabling brake profile selection.

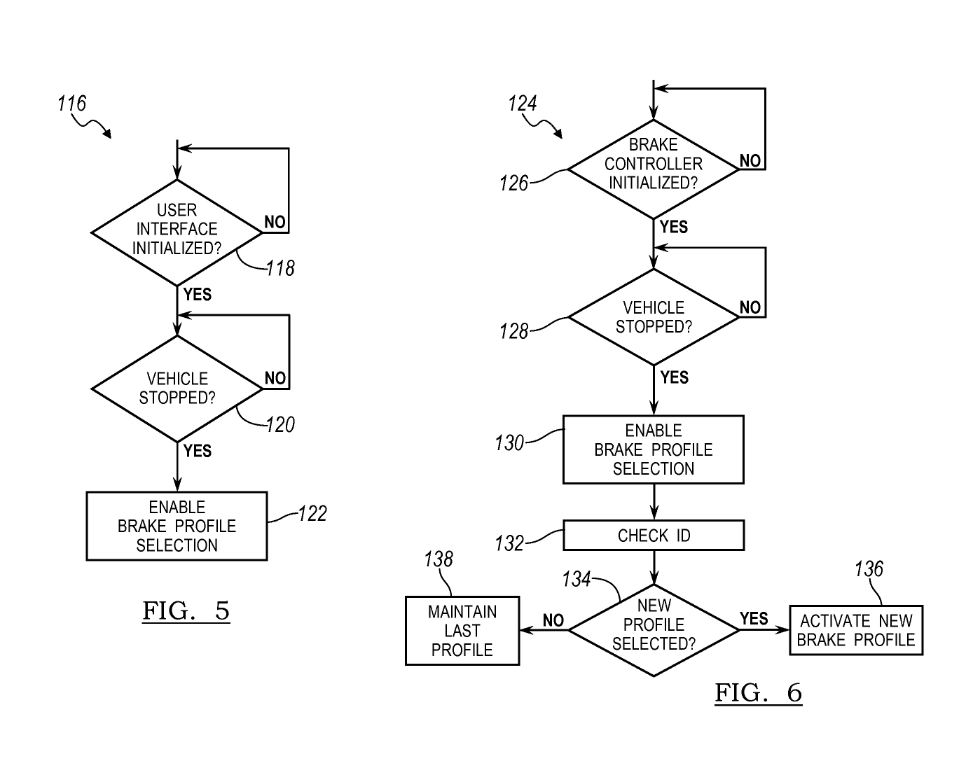

FIG. 5 illustrates a method for selecting a brake profile, which is generally referenced by numeral 116. In step 118 the user interface 90 determines if it is initialized. This initialization step 118 may include receiving sufficient electrical power, and establishing communication with the vehicle communication network and the brake controller 16. The user interface will remain at step 118 until initialization is completed.

In step 120, the user interface 90 determines if the vehicle is stopped, by analyzing the gear selection signal (GEAR SELECTION) and the wheel speed signals (WSS1-4). If the GEAR SELECTION signal indicates that the vehicle is in PARK, and the WSS1-4 signals indicate that the vehicle is traveling less than one kph; then the user interface 90 determines that YES, the vehicle is stopped (not moving). If the vehicle is stopped, the user interface 90 proceeds to step 122 and enables brake profile selection. However, if the user interface 90 determines that the vehicle is moving, then the user interface will remain at step 120. The user interface may also display a message corresponding to the enablement of the brake profile selection at step 122. In one embodiment of the method 116, the user interface 90 analyzes at least one of the accelerator position signal, the gear selection signal and the wheel speed signal during step 120, to determine if the vehicle is stopped.

FIG. 6 depicts a method for activating a selected brake profile, which is generally referenced by numeral 124. In step 126, the brake controller 16 determines if it is initialized. This initialization step 126 may include receiving electrical power, and establishing communication with the vehicle communication network, the user interface 90 and the vehicle controller 92. The brake controller 16 will remain at step 126 until initialization is completed.

In step 128, the brake controller 16 determines if the vehicle is stopped, by receiving and analyzing the gear selection signal (GEAR SELECTION) and the wheel speed signals (WSS1-4). If the GEAR SELECTION signal indicates that the vehicle is in PARK, and the WSS1-4 signals indicate that the vehicle is traveling less than one kph; then the brake controller determines that YES, the vehicle is stopped (not moving). If the brake controller 16 determines that YES, the vehicle is stopped, the brake controller 16 proceeds to step 130 and enables brake profile selection. However, if the brake controller 16 determines that the vehicle is moving, then the brake controller 16 will remain at step 128. In one embodiment of the method 124, the brake controller 16 analyzes at least one of the accelerator position signal, the gear selection signal and the wheel speed signal during step 128, to determine if the vehicle is stopped.

In step 132, after the brake profile selection is enabled, the brake controller 16 checks to see if an identification signal (ID) has been received. If an ID signal has been received, then the brake controller 16 analyzes the ID signal to determine if a brake profile has already been saved corresponding to the ID. If a brake profile has been saved, then the brake controller activates the previously saved brake profile.

In step 134, the brake controller 16 checks to see if a brake profile selection signal (BRAKE SELECTION) has been received. Next the brake controller 16 analyzes the BRAKE SELECTION signal to determine if the selected brake profile is NEW or different from a current brake profile (e.g., the default brake profile or a previously selected brake profile). If YES, the BRAKE SELECTION is NEW, then the brake controller 16 will proceed to step 136 and set the new brake profile. If NO, the BRAKE SELECTION is not new, then the brake controller 16 will proceed to step 138 and maintain the current brake profile. Also in step 138 the brake controller may set the brake profile to the ID signal.

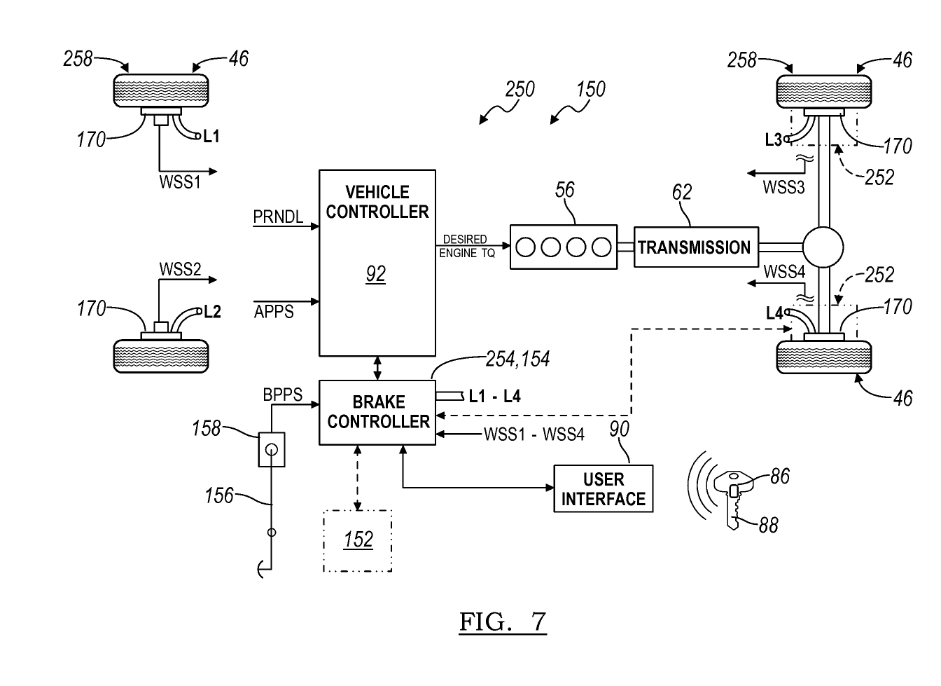

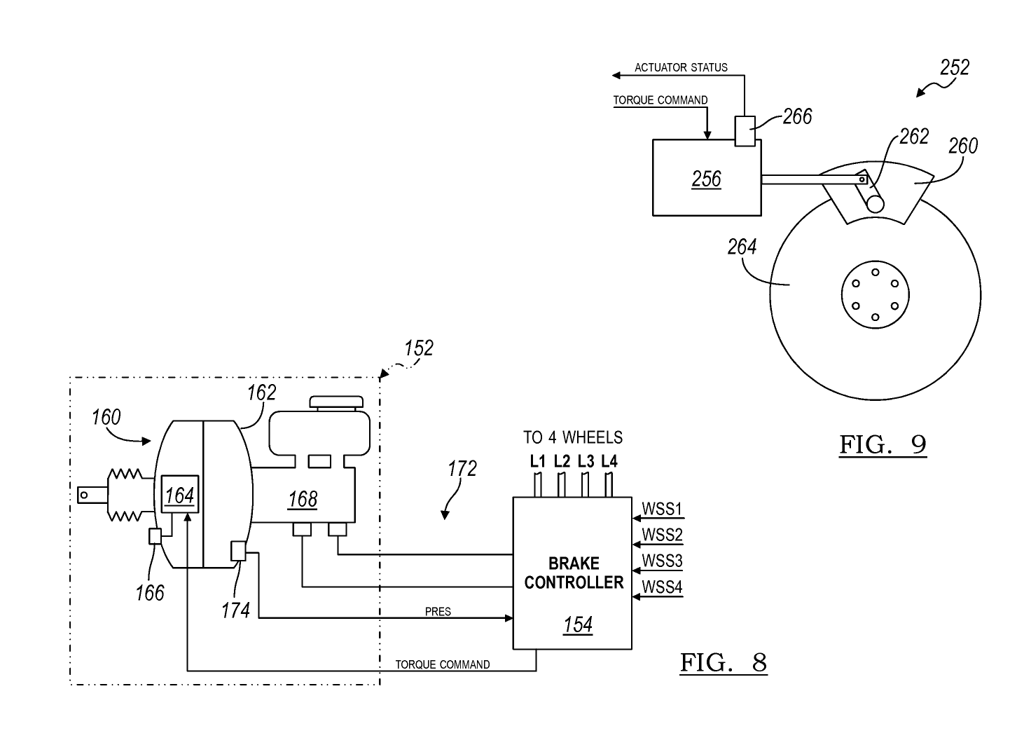

With reference to FIGS. 7 and 8, a system for customized vehicle deceleration is illustrated in accordance with another embodiment and is generally referenced by numeral 150. The system 150 includes a braking system 152 that is electronically controlled by the brake controller 154.

The system 150 includes a brake pedal 156 for receiving a mechanical input from a user. A brake pedal position sensor 158 is coupled to the brake pedal 156 for providing a brake pedal position signal (BPPS) that is indicative of a brake pedal position.

The braking system 152 includes an active booster 160 in communication with the brake controller 154. The active booster 160 is mechanically disconnected from the brake pedal 156. The active booster 160 includes a hollow body 162 having two chambers that are separated by a flexible diaphragm. A booster actuator 164 is provided for adjusting an internal pressure within the body 162. The booster actuator 164 is connected to an air valve 166. The booster actuator 164 actuates (opens and closes) the air valve 166 in response to a TORQUE COMMAND signal from the brake controller 154. By opening the air valve 166, a pressure differential develops in the body 162 to provide a booster output pressure. The active booster 160 is connected to a master cylinder 168. The master cylinder 168 is coupled to brake calipers 170 by a hydraulic system 172, to provide a wheel torque acting on a rotating member to decelerate the vehicle.

The braking system 152 includes a booster sensor 174 for measuring an internal pressure within the body 162. The booster sensor 174 provides an input signal (PRES) to the brake controller 156 that is indicative of the internal pressure.

With reference to FIGS. 7 and 9, a system for customized vehicle deceleration is illustrated in accordance with yet another embodiment and is generally referenced by numeral 250. The system 250 includes a braking system 252 for decelerating a vehicle. The system 250 also includes a brake controller 254 for electronically controlling the braking system 252.

The braking system 252 includes at least one actuator 256 in communication with the brake controller 254. The actuator 256 is mounted to a wheel assembly 258 for applying a frictional braking torque to a rotating member of the wheel assembly 258. The system 250 may include an actuator 256 at each of four wheel assemblies 256. The actuator 256 may include a motor and geartrain for providing a linear output. The actuator 256 is mechanically connected to a brake caliper 260. For example the brake caliper 260 may include an external lever 262 for actuating an internal piston to apply a clamp load to a rotor 264.

The actuator 256 actuates the lever 262 in response to a TORQUE COMMAND signal from the brake controller 254. By actuating the lever 262, the caliper 260 provides a wheel torque to decelerate the vehicle.

The braking system 252 includes an actuator sensor 266 for measuring a status of the actuator 256. The actuator sensor 266 may measure a position of the actuator 256, or a current provided to the actuator 256. The actuator sensor 266 provides an input signal (ACTUATOR STATUS) to the brake controller 256.

While the best mode for carrying out the invention has been described in detail, those familiar with the art to which this invention relates will recognize various alternative designs and embodiments for practicing the invention as defined by the following claims. Additionally, the features of various implementing embodiments may be combined to form further embodiments of the invention.

What is claimed:

1. A system for customized vehicle deceleration, the system comprising:
a braking system;
a brake pedal position sensor for transmitting a brake pedal position signal;
a user interface configured for transmitting a profile selection signal in response to a user input; and
a controller configured for:
receiving the brake pedal position signal, the profile selection signal and an available torque signal, the available torque signal being indicative of a braking system torque capability;
analyzing the profile selection signal to select a brake profile from pre-existing data,
comparing the brake pedal position signal to the brake profile to determine a deceleration value,
comparing the deceleration value to the available torque signal to determine a torque command, and
transmitting a torque command signal to the braking system for initiating braking.

2. The system of claim 1 wherein the controller is configured with pre-existing data comprising calibration data including a plurality of brake profile curves, each brake profile curve being defined by a series of data points having a brake pedal travel component and a vehicle deceleration component.

3. The system of claim 1 wherein the at least one receiver further comprises a first receiver for receiving an identification signal indicative of an ignition key.

4. The system of claim 3 wherein the controller is configured for analyzing the identification signal and the profile selection signal for setting a brake profile associated with the identification signal.

5. The system of claim 4 wherein the controller is configured for comparing the identification signal to pre-existing data to select the brake profile.

6. The system of claim 1 further comprising a transmitter for transmitting a brake status signal in response to the selected brake profile.

7. The system of claim 6 wherein the user interface is configured for displaying a brake status message corresponding to the brake status signal.

8. The system of claim 7 wherein the user interface is configured for transmitting the profile selection signal in response to an audible input.

9. A vehicle braking system comprising:
a controller configured to:
receive a brake pedal position signal and a profile selection signal;
select a brake profile based on pre-existing data and the profile selection signal;
compare the brake pedal position signal to the brake profile to determine a deceleration value; and
determine a torque command using the deceleration value.

10. The system of claim 9 further comprising:
a hybrid electric transmission having at least one motor configured for regenerative braking a vehicle;
a vehicle controller in communication with the controller and the hybrid electric transmission, the vehicle controller configured to:
determine a regenerative torque capability of the hybrid electric transmission, and
transmit an available torque signal to the controller that is indicative of the regenerative torque capability.

11. The system of claim 10 wherein the controller is further configured to:
compare the deceleration value to the available torque signal to determine the torque command; and
transmit a torque command signal to the vehicle controller for initiating regenerative braking in response to the torque command.

12. The system of claim 9 further comprising:
an active booster in communication with the controller, the active booster comprising:
an enclosed body, and
a booster actuator for adjusting an internal pressure within the body; and
a booster sensor for measuring the internal pressure within the body and providing a booster pressure signal to the controller.

13. The system of claim 12 further comprising a transmitter for transmitting a torque command signal to the active booster for actuating the booster actuator in response to the torque command.

14. The system of claim 9 further comprising:
at least one brake actuator in communication with the controller and coupled to a wheel assembly for applying a friction brake; and
an actuator sensor for providing an actuator status signal to the controller.

15. The system of claim 14 further comprising a transmitter for transmitting a torque command signal to the at least one brake actuator for applying the friction brake in response to the torque command.

16. A method for controlling a customized vehicle deceleration system, the method comprising:
receiving a brake pedal position signal;
receiving a profile selection signal;
analyzing the profile selection signal to select a brake profile from pre-existing data;
comparing the brake pedal position signal to the brake profile to determine a deceleration value;
analyzing the deceleration value to determine a torque command; and
transmitting a torque command signal indicative of the torque command.

17. The method of claim 16 further comprising:
receiving a identification signal indicative of an ignition key;
analyzing the identification signal and the profile selection signal for setting a brake profile associated with the identification signal; and
comparing the identification signal to pre-existing data to determine the brake profile.

18. The method of claim 16 further comprising:
receiving an available torque signal;
comparing the deceleration value to the available torque signal to determine the torque command;
transmitting the torque command signal to a vehicle controller for initiating regenerative braking; and
transmitting a brake status signal indicative of the brake profile.

19. The method of claim 16 further comprising:
receiving a transmission gear selection signal;
receiving a wheel speed signal; and
receiving an accelerator pedal position signal.

20. The method of claim 19 further comprising enabling customized brake profile selection in response to at least one of the transmission gear selection signal, the wheel speed signal and the accelerator pedal position signal.
